(19) United States
(12) Patent Application Publication
(10) Pub. No.: US 2003/0007852 A1
(43) Pub. Date: Jan. 9, 2003

(54) Piano and organ transporting apparatus and method

(76) Inventor: Boris Bernards, Chatsworth, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/193,551

(22) Filed: Jul. 9, 2002

Related U.S. Application Data
(60) Provisional application No. 60/303,936, filed on Jul. 9, 2001.

(51) Int. Cl. B66F 7/00

(52) U.S. Cl. 414/460

(57) ABSTRACT

A piano-transporting apparatus includes a three-sided frame with a rear side and a pair of parallel, transversely-extending sides with an open front, thereby forming a rectangularly-shaped pocket for receiving a piano. A longitudinal bar on the rear section carries a pair of forwardly-projecting hooks which are capable of engaging the piano either at the base thereof or along the upper back portion. Strap means are provided for securing the upper end of the piano with respect to the frame. A drive mechanism, such as a hydraulic arrangement can be used for raising the hooks and thereby lifting the piano from the floor or other supporting surface. The frame is mounted on rollers so that it can be easily transported. The apparatus is highly effective in that it enables a single person to secure, lift, and transport a piano. A method of utilizing this apparatus is also disclosed.

### RELATED APPLICATION

This application claims priority from Provisional Application Serial No. 60/303,936, filed Jul. 9, 2001.

### BACKGROUND OF THE INVENTION

The present invention relates generally to piano-moving devices, and more particularly to a piano-moving apparatus and method which utilizes a plurality of hooks capable of engaging a piano and lifting the same from a ground surface so that the piano may be transported on the apparatus by a single individual.

While repairs of pianos are relatively infrequent, they often necessitate transporting a piano to a piano repair shop. Some repairs can be made on-site, but in numerous cases, the piano must be moved to the piano shop. The weight and bulk of a typical piano usually requires several persons to lift the same onto a dolly and push the loaded dolly to a new location or load the same into a truck for conveyance. Therefore, moving a piano anticipates and requires several strong men or women to be present for lifting the piano and carrying the same to a vehicle for transport.

At a piano repair shop, or in a retail showroom where pianos are on display, with a back of a piano abutted against a flat wall or even in a freestanding position, the problems of movement for even short distances are substantial. In some cases, pianos are not mounted on rollers. Even when mounted on rollers, the so-called “upright” piano is tall and relatively thin, with a substantial portion of its mass located at some distance from the ground surface. Accordingly, movement of an upright piano requires care so that the piano is not inadvertently tipped over, which would result in substantial damage to the piano.

In order to properly move any piano, with or without rollers, at least two or more individuals are required. This creates a substantial problem at many piano shops since there may be only one person available to move a piano. Uneven surface flooring also impedes movement of a piano even with two or more people. In order to avoid this problem, piano shops have to provide facilities with a larger surface area than would otherwise be required so that piano movement is maintained at an absolute minimum.

Even when pianos are provided with rollers, their upright nature and substantial weight and bulk render them difficult to maneuver, particularly on carpet surfaces or on uneven floor surfaces. They are particularly difficult to maneuver or move on street surfaces which are not smooth or flat.

In addition, there are many occasions in which a repairman must have access to the base of the piano, particularly for piano pedal repairs or for repairing the base plate of the piano. In this case, it is necessary to raise the piano by some mechanism or otherwise to tilt the piano on its back so that access can be obtained. At least two fairly strong people are required to lift and lay a piano on its back surface so that access may be obtained to the base portion thereof. In addition, a piano laid on its back consumes a substantial amount of repair space.

There have been various so-called “mover's trucks” which are used for moving pianos. The mover's truck primarily comprises an upright frame with a vertically-shiftable member carrying a plurality of hooks. These hooks are adapted to engage the underside of the piano or at least some portion of the piano. A lever arm is used to raise the shiftable member and the hooks, thereby raising the piano. However, two of these trucks are required to move any piano with one truck positioned at each end of an upright piano. A lever arm is provided for raising the moveable member and even though a mechanical advantage is afforded, a substantial amount of effort is nevertheless required to raise a piano.

There is another type of piano mover which employs a caterpillar-type, continuous rubber belt. The piano is carried on a platform supported by this belt. However, the piano must be laid on its back or top. This type of device is effective for climbing stairs, but has a number of drawbacks: First, the device cannot be easily maneuvered around corners. Second, several personnel are required to operate the device. Further, the device is bulky and consumes a substantial amount of space. Finally, the device itself is quite heavy, thereby requiring several personnel to move the same to a storage position.

Accordingly, there is a need for a piano-moving apparatus which is light in weight and which enables a single person to move a piano.

### OBJECTS OF THE INVENTION

It is, therefore, one of the primary objects of the present invention to provide a piano-moving apparatus which is capable of being utilized for moving pianos with or without rollers on the base thereof by a single individual.

It is another object of the present invention to provide a piano-moving apparatus of the type stated, in which the piano is securely held on a frame and can be moved a substantial distance by a single individual without the need of any assistance from any second party.

It is a further object of the invention to provide a piano-moving apparatus of the type stated which is easily utilized by one individual and requires very little manual force for either loading the piano onto the apparatus or moving the same from one location to another.

It is yet another object of the present invention to provide a piano-moving apparatus of the type stated which is relatively effective in its operation and which can be produced at a relatively low cost.

It is still another object of the present invention to provide a piano-moving apparatus of the type stated which allows a single individual to load and place a vertical upright piano in a position where its back is disposed against a wall in the conventional position for use and also for placing the same adjacent other pianos in a restricted space.

It is still another salient object of the present invention to provide a method of moving a piano by a single individual utilizing a specially-designed lifting and transporting frame.

With the above and other objects in view, my invention resides in the novel features of form, construction, arrangement and combination of parts presently described and pointed out in the claims.

### BRIEF SUMMARY OF THE INVENTION

This invention relates in general to certain new and useful improvements in a piano-moving apparatus, and an associated method which relies upon a specifically-designed, unique frame for both lifting and transporting the piano. The frame employed is essentially a three-sided frame, containing a back section and a pair of transverse, spaced-apart sides which are disposed parallel to each other. The front portion of the frame is open and forms a rectangularly-shaped, forwardly-opening pocket for receiving a piano.

The frame is generally comprised of a lower, longitudinally-extending rear frame bar and a pair of transversely-extending, spaced-apart side frame bars. Mounted on the rear frame bar is a piano-lifting assembly which is generally an upright structure with a vertically-shiftable lifting bar. This lifting bar is capable of being raised and lowered in order to effectively raise and lower a piano. A pair of hooks are mounted on the lifting bar and extend forwardly so as to extend under and engage the bottom of a piano near the rear surface thereof or a horizontal beam at the rear surface of the piano.

A drive mechanism such as a hydraulic ram is connected to the lifting bar and is capable of raising and lowering the same by manual actuation by a single operator. The drive mechanism may be a manually-actuable drive mechanism so as to cause a raising of the lifting bar by a pumping action or it may be a powered drive mechanism for causing the raising of the lifting bar through an electric drive motor or the like.

A front lifting assembly can also be located on the lifting bar for orienting the piano in the pocket such that the front of the piano faces rearwardly. In this case, hooks will also extend under a portion of the piano for engaging and lifting the same. In this mode of operation, a strap mechanism extends around the piano and is secured to the lifting assembly so as to firmly hold the piano in a fixed position on the frame.

This invention possesses many other advantages and has other purposes which will be more apparent from a consideration of the forms in which it may be embodied. One of the forms of the piano moving apparatus has been illustrated and described in the subsequent written description and the following appended drawings. However, it is to be understood that this written description and the detailed drawings are only for purposes of illustrating the general principles of the invention and that the description and the drawings are not to be taken in a limiting sense.

### BRIEF DESCRIPTION OF THE DRAWINGS

The accompanying drawings illustrate the invention. In such drawings:

Having thus described the invention in general terms, reference will now be made to the accompanying (three sheets) in which:

FIG. 1 is a perspective view of a piano-transporting apparatus constructed in accordance with and embodying the present invention;

FIG. 2 is a perspective view of a hook used with the piano moving and transporting apparatus of the present invention;

FIG. 3 is a side elevational view showing a piano secured to the piano-transporting apparatus of the present invention;

FIG. 4 is a sectional view taken along line 4-4 of FIG. 1;

FIG. 5 is a perspective view of an alternate form of piano hooks which can be used in accordance with the present invention;

FIG. 6 is a perspective view of a piano-transporting apparatus using still another alternate form of piano hook in accordance with the present invention; and

FIG. 7 is a perspective view of still a further modified form of piano hook which can be used in accordance with the present invention.

### DETAILED DESCRIPTION OF THE PREFERRED EMBODIMENT

Reference is now made in more detail and by reference characters to the drawings which illustrate practical embodiments of the present invention, which is generally embodied in a piano-moving apparatus.

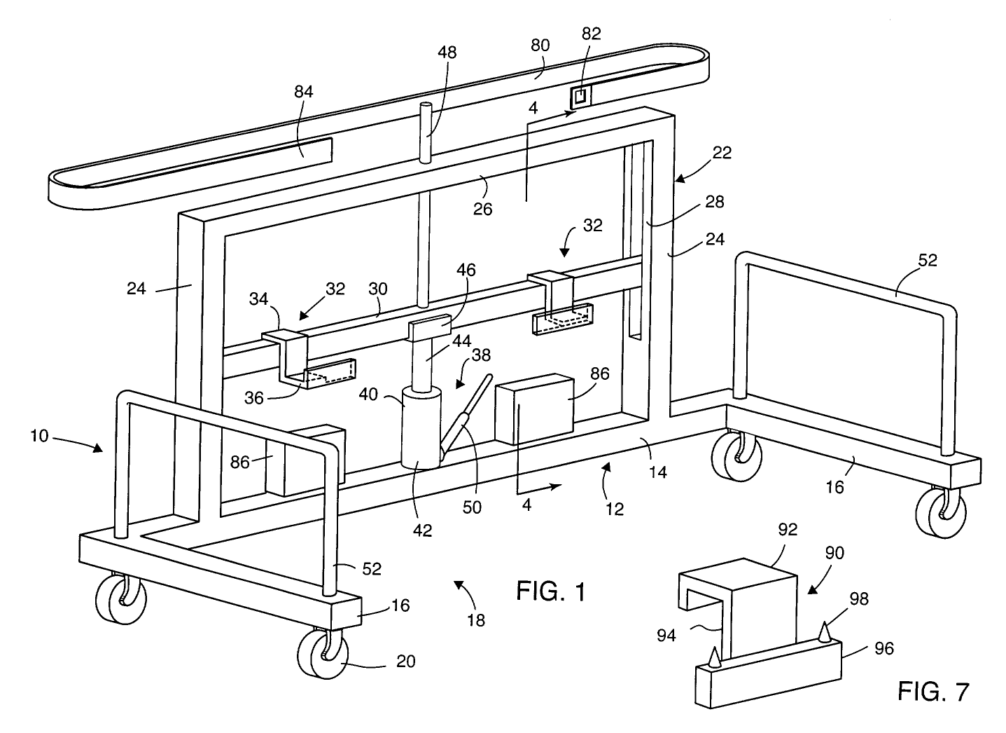

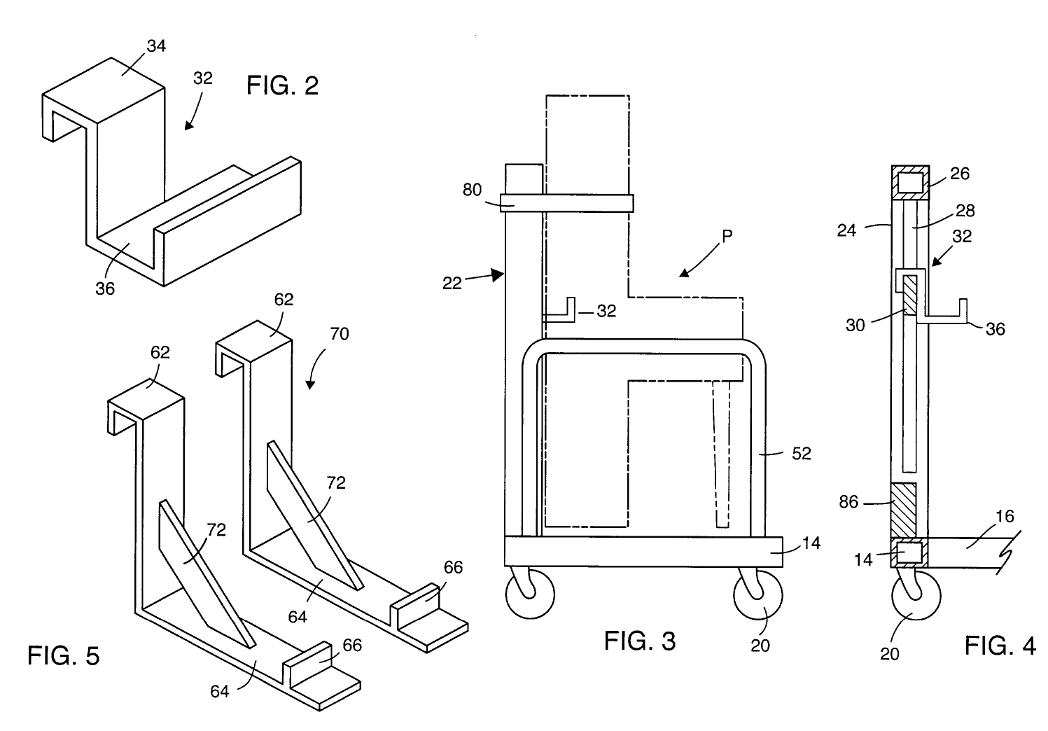

Referring now to FIG. 1, the piano-moving apparatus comprises a main frame 10 having a three-sided base frame 12. This base frame 12 is comprised of a longitudinally extending rear frame bar 14 and a pair of transversely-spaced-apart side frame bars 16. In this case, it can be observed that the base frame has an open, forwardly-facing portion thereby defining a rectangularly-shaped pocket 18.

The base frame 12 is also provided on its undersurface with conventional casters or rollers 20 for movement. In the embodiment as illustrated, four individual casters have been shown. However, in some cases, it may be desirable to employ combinations of fixed rollers and rotable casts or the like. Furthermore, a powered drive roller or powered drive wheels could also be provided if desired.

Mounted on the base frame and particularly on the longitudinally-extending frame bar 14, is an upright frame 22 which is comprised of a pair of vertically-arranged, longitudinally-spaced-apart upright frame bars 24 connected at their upper end by a horizontally-extending frame bar 26.

The main frame 10 comprising the base frame 12 and the generally upright frame 22 is formed of steel members. However, it should be understood that other materials of construction may substitute for steel. Other metals can be employed, and non-metals like reinforced plastic composite materials and the like can also be used.

The vertically-extending, longitudinally-spaced-apart frame bars 24 are each provided on their surfaces with elongate slots 28 for accommodating a vertically-shiftable member 30. In this case, it can be observed that the vertically-shiftable member has longitudinal ends which extend in the opposed vertically-arranged slots 28 so as to capture the vertically-shiftable member 30 and to provide for vertical movement of the member 30 in the slots 28.

As illustrated, the vertically-shiftable member 30 carries a pair of longitudinally-spaced-apart hooks 32. These hooks are comprised at one end of an inverted, U-shaped section 34 fitted over the upper surface of the vertically-shiftable member 30. At their other ends, the hooks 32 have a somewhat U-shaped hook section 36. These hook sections 36 are adapted to extend under and engage a horizontal wooden frame member of the piano, and particularly in a so-called upright piano.

The piano-moving apparatus of the present invention is useful and highly effective for moving upright pianos. However, it is also effective for moving other types of pianos and organs.

The hooks 32 are loosely but retentively fitted on the vertically-shiftable member 30. In this way, the hooks 32 can be shifted to a desired position in order to engage a horizontal beam on the upright piano.

A drive means 38 is also provided for raising and lowering the vertically-shiftable member 30. In the embodiment as illustrated, the drive means 38 comprises a hydraulic piston-cylinder arrangement 40, including a cylinder 42 fixed mounted on the longitudinally-extended frame bar 14 and a vertically-extensible piston 44. The upper end of the piston 44 is provided with a U-shaped hook 46 which engages the underside of the vertically-shiftable member 30. In this way, when the piston 44 is extended, it can raise the vertically shiftable member 30, and when the piston is lowered into the cylinder 42, the shiftable member 30 lowers within the slots 28.

A vertically-arranged guide rod 48 is mounted on the piston 44 and extends through the vertically-shiftable member 30 and the upper, longitudinally-extending frame bar 26. In this way, the vertically-shiftable member 30 is maintained in an aligned position during its vertical movements.

As illustrated, the drive means 38 is manually actuable, and is provided with a crankable handle 50. Thus, when the user of the piano-moving apparatus wishes to raise the vertically-shiftable member 30, he or she can merely crank the handle 50. By twisting the handle 50, a release valve in the cylinder 42 will permit a lowering of the piston 44 into the cylinder 42. This type of arrangement is conventionally found in portable hydraulic lifts used in automotive service stations and the like.

To transport a piano, the piano must first either be moved into the forwardly-opening pocket 18. This can be accomplished by moving the piano itself, or, preferably, by moving the main frame 10 of the piano-moving apparatus such that the forwardly-opening pocket 18 envelopes the piano. The transversely-extending frame bars 16 are also provided with upwardly-extending rails 52 for engagement by a user of the apparatus and for channeling the piano into the pocket 18. In order to raise the piano, the hooks 32 are located so that they engage the underside of a horizontal beam (not shown) at the rear portion of the piano. Thereafter, the user of the apparatus can manually actuate the handle 50 in order to cause a raising movement of the vertically-shiftable member 30 and the hooks 32. As this occurs, the piano will be lifted.

The side frame bars 16 are provided with rails, railings, or upright enclosures 52. These railings 52 define an overall pocket with some vertical dimension for receiving the piano and may be used to pull or push the entire apparatus with the piano suspended therein. The railings 52 may be welded or otherwise suitably secured to the upper surface of each of the side frame bars 16.

The side frame bars 16 and the railings 52 may be hingedly mounted with respect to the longitudinally-extending frame bar 14. The two side frame bars 16 could then be pivoted so as to lie parallel to the frame bar 14 for purposes of storage, transport, and shipment. This hinged connection is easily accomplished by merely providing hinges at the ends of each of the side frame bars 16 for attachment to the ends of the longitudinal frame bar 14. Further, a suitable locking means may be provided in order to hold the side frame bars 16 in an open position. Any mechanism for hingedly connecting the side frame bars 16 could be used, and therefore it is neither illustrated nor described in detail hereafter.

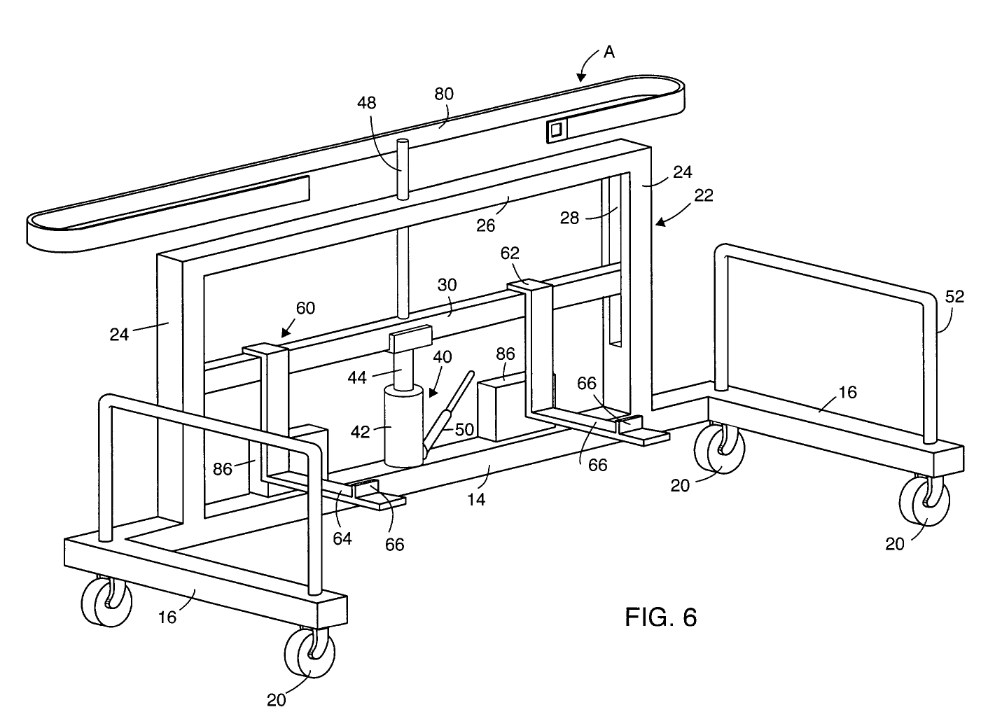

Referring now to FIG. 6, the present invention also provides alternate hooks 60 which can be used on the vertically-shiftable member 30 for raising and lowering a piano. In this case, the hooks 60 are provided with a U-shaped section 62 capable of extending over the upper portion of the vertically-shiftable member 30. The hooks 60 are also provided with elongate, horizontally-extending legs 64 for engaging the underside of the piano. Vertically-struck retaining tabs 66 may also be welded or otherwise rigidly secured to the upper surface of the legs 64. This alternate type of hook arrangement 60 is preferable with certain models of pianos where it is difficult to use the hooks 32.

Referring now to FIG. 5, the present invention also provides an alternative hook 70, which is very similar to the hook 60 except that the hook 70 includes diagonally arranged struts 72. This type of hook 70 is effective where it is desired to engage a beam at the front portion of a piano and where the struts 72 would not otherwise interfere with engagement of the piano.

Referring to FIG. 3, a belt 80 is provided for wrapping around the upper portion of the piano and the upright frame 22. However, the belt is generally only required when hooks 70 are employed. While FIG. 3 illustrates the belt 80 in connection with hooks 32, the belt 80 is not normally thus employed unless additional safety concerns exist. When the hooks 32 are employed, there is no need to use the belt 80. As shown in FIG. 1, the belt 80 is also provided with a suitable hook 82 for releasably locking the free end 84 of the belt.

Referring again to FIG. 1, the longitudinally-extending frame bar 14 is provided with a pair of upwardly-struck retaining plates 86. These retaining plates 86 are designed to engage the lower end of the piano or organ when either is lifted upwardly by the hooks 32. In this way, the hooks 32 will engage some portion of the piano and the base portion of the piano will be engaged by the retaining plates 86, thus allowing the piano to be suitably braced while in an elevated position.

FIG. 7 illustrates a further modified hook 90 which may be used with the piano-moving apparatus of the present invention. In this case, the hook 90 comprises a U-shaped member 92 for disposition over the vertically-shiftable member 30 along with a depending plate 94. Welded or otherwise rigidly secured to the plate 94 is an elongate arm 96 having a pair of vertically-extending, relatively sharp projections or spikes 98. These sharpened projections 98 are designed to literally engage and spike or project into a wooden cross member at the back of a vertical upright piano. Most upright pianos have an enlarged wooden plate or beam along the back, immediately rearward of the soundboard ribs. Thus, the spikes or projections 98 will effectively bite into this cross member and thereby effectively hold the piano when the vertically-shiftable member 30 raises the piano.

The piano-moving apparatus of the present invention is highly effective in that it enables a piano to be moved by a single individual. Moreover, the piano can be moved without additional devices. Two or more people are not required to mount or move the piano. Heretofore, at least two or more persons have been required to move a piano even for a limited distance. This piano-moving apparatus is easy to use and constructed of relatively inexpensive components.

The terms “piano-moving apparatus” and “piano-transporting apparatus” are used in a broad sense to encompass other types of instruments similar to pianos, such as organs, both of the mechanical type and of the electronic type.

Thus, there is illustrated and described a unique and novel system and method for a piano-moving apparatus which enables a piano or an organ to be moved by an individual on a relatively simple basis. The present invention thereby fulfills all of the objects and advantages which have been sought. It should be understood that many changes, modifications, variations and other uses and applications will become apparent to those skilled in the art after considering this specification and the accompanying drawings. Therefore, any and all such changes, modifications, variations, and other uses and applications which do not depart from the spirit and scope of the invention are deemed to be covered by the invention.

What is claimed is:

1. A piano-moving apparatus, comprising:
a base frame which partially surrounds a piano or similar instrument;
rollers associated with the base frame, whereby the base frame may be moved;
an upright frame attached to the base frame;
a piano-engaging system, moveably associated with the upright frame, whereby a piano may be secured; and
a lifting device associated with the piano-engaging system, whereby a piano may be lifted and suspended above the ground.

2. The apparatus of claim 1, wherein the piano-engaging system is slidably attached to the upright frame.

3. The apparatus of claim 1, wherein the piano-engaging system includes a plurality of hooks.

4. The apparatus of claim 3, wherein the hooks are capable of engaging a piano either from the side or bottom.

5. The apparatus of claim 1, wherein the lifting device may be manually operated by a single person.

6. The apparatus of claim 5, wherein the lifting device comprises a hydraulic lift.

7. The apparatus of claim 1, including a harness, whereby a piano may be enwrapped and additionally secured.

8. A piano-moving apparatus, comprising:
a base frame which partially surrounds a piano or similar instrument;
rollers associated with the base frame, whereby the base frame may be moved;
an upright frame attached to the base frame;
a piano-engaging system, slidably attached to the upright frame, whereby a piano may be secured;
a hydraulic lift, operable by a single person and associated with the piano-engaging system, whereby a piano may be lifted and suspended above the ground; and
a harness, whereby a piano may be enwrapped and additionally secured.

9. The apparatus of claim 8, wherein the piano-engaging system includes a plurality of hooks.

10. The apparatus of claim 9, wherein the hooks are capable of engaging a piano either from the side or bottom.
